(19) United States
(12) Patent Application Publication
(10) Pub. No.: US 2003/0204844 A1
(43) Pub. Date: Oct. 30, 2003

(54) Video messaging system

(76) Inventors: Steven B. Brant, New Glouchester, ME (US); George A. Brust, Baltimore, MD (US)

Correspondence Address: ARMSTRONG, WESTERMAN & HATTORI, LLP, 502 Washington Avenue, Suite 220, Towson, MD, 21204, US

(21) Appl. No.: 10/134,246

(22) Filed: Apr. 26, 2002

(51) Int. Cl. H04N 7/16; H04H 9/00; H04N 7/025; H04N 7/10; H04N 7/00; H04N 11/00; H04N 5/38

(52) U.S. Cl. 725/22; 725/34; 725/35; 725/135; 348/461; 348/723

(57) ABSTRACT

Advertising spots are generated globally, and are subsequently adapted to satisfy one or many local applications. The adaptations are initiated most preferably by an advertiser through encrypted Internet access to a hub in real time. Adaptations, station verification, adapting the actual video/audio stream, logging and invoicing are all performed automatically and in real time. Consequently, an advertiser can modify a global spot for one or more local broadcasts, and can immediately ascertain effectiveness of the modification. Various modifications to the basic steps are disclosed that further enhance the utility of the method.

### CROSS REFERENCE TO RELATED APPLICATIONS

This application claims priority to presently pending U.S. provisional application serial No. 60/______, filed on ______, the contents which are incorporated herein by reference in entirety.

### BACKGROUND OF THE INVENTION

1. Field of the Invention

The present invention pertains generally to the field of advertising. In one more particular manifestation the present invention pertains to a method of providing “SPINNER” advertising spots with inner messages that enable an advertiser to develop custom messages on demand.

2. Description of the Related Art

Advertising has traditionally been a form of art which is evaluated rather subjectively. A particular advertising campaign or promotion may be very difficult to monitor, if in fact there is any way to evaluate the success of the campaign. Furthermore, there is often a great deal of expense involved in developing the advertising campaign, so there is little opportunity for refining the campaign. Essentially, an advertiser must first consult with an advertising department or agency, discuss the goals and objectives for the campaign, determine a cost target for the project, develop one or more proposed approaches, and then evaluate the proposed campaign either based upon the emotional response of corporate executives or upon very limited test audiences. The exposure to test audiences adds substantial expense, since the approach has to be reasonably well developed in order to obtain an accurate representation of the effectiveness. In the event the advertising is not selected, the monies spent during the development of the campaign may be wasted. Even if the campaign is selected, there is rarely any objective method for evaluating results. Typically this is because an advertiser will be pursuing many different promotional campaigns, and the time period for evaluation may be measured by monthly or quarterly reports, which are much too slow to determine the effectiveness of a single promotion, such as a one-day or one-week special.

Because of the relatively high cost of development of an advertising spot for television and other combined audible and visual media (hereinafter “A/V”), and the relative difficulty heretofore modifying the combined A/V spot, there is little or no opportunity for customizing an advertising spot to a time of day, broadcast station, or even a locale. Consequently, video advertisement, hereinafter referred to as spots or commercials, tend to be relatively fixed both through time and also through distribution or presentation channels, while other media such as newsprint, magazines, radio and the like are more readily modified on a daily or periodic basis. For example, a local advertisement through the radio may be altered on a time of day, day of the week or weekly basis for much less cost than was heretofore possible with video avenues such as television and like. Consequently, video spots have traditionally been limited to widely distributed advertising by larger businesses and institutions who are attempting to gain brand-name recognition, or where a major new product launch or special merits the development of a widely distributed television advertisement. There has heretofore been little opportunity to use television spots to target specific audiences.

For the purposes of the present disclosure, video media and television will be considered to be synonymous, and yet not limited solely to television. Other combined audio and video distribution media and techniques will be understood to be incorporated herein when reference is made to video or television, whether the broadcast is through satellite, television radio wave broadcast, cable, computer, Internet or the like. Additionally, the use of the terms global, local and locale will not be limited solely to one definition or another for these words. For example, global will be understood to imply a plurality of locales whether global refers to a small geographic region which is subdivided into the locales or includes a world-wide coverage. Furthermore, global will be understood by those skilled in the art to sometimes be separate from any geographic meaning at all, and may, for exemplary purposes only but not considered to be limiting herein, encompass a plurality of channels, each one considered to be a local channel where a combination or subcombination of local channels is referred to as global.

Beyond verifying effectiveness of advertising, the motivation for advertising may also change with the product or service being promoted, or over a period of time, also leading to a desire to change the advertising spot. In some instances, the advertising may be motivated by a desire for recognition in the marketplace, such as might be required with a new product, business, or political candidate. In other instances, the persuasion of an audience may be most important, for example when a firmly established business wishes to gain market share from other established businesses. In other instances, the education of the audience may be important, such as when a product is introduced which offers benefits that weren't believed possible previously, or with public service announcements such as anti-drug campaigns, or when one political candidate has been unfairly maligned by another. These motivations, for the same business, service, product, political candidate, or other advertising topic may additionally change over time. A new product, once recognized in the marketplace as an option, will then desirably be promoted to obtain significant market share.

These different motivations for advertising further increase the complexity of designing and selecting content for an advertising spot. Where a spot must exist for significant time without direct measure of effectiveness, the success or failure of the spot is difficult to judge, leaving the effectiveness to be ascertained primarily based upon the emotion of the advertiser and the feedback from a small group of persons who may not necessarily be representative of a true audience. Consequently, advertising money is much more effective where there are opportunities for more immediate measure and comparison, which also necessitates more rapid changes in the content of the advertising spot.

Television, which is widely recognized as a superior advertising medium owing to combined audio and video which leads to a much greater sensory experience, has suffered some undesired setbacks recently. The broadcasters are anticipating substantial increases in mandated spending, while there is little opportunity available for the broadcasters to increase revenue. What is desired then is a way to increase perceived value to advertisers, while maintaining production costs.

Some progress has been made by both Lindstrom, in U.S. Pat. No. 5,029,014, and also by Esch et al in U.S. Pat. No. 5,099,319. The disclosures of each of these patents are incorporated herein by reference for their teachings of how some of the components of a video system operate and may be assembled. Nevertheless, these patents still require inordinate human intervention and do not offer the desired flexibility and value to advertisers.

### SUMMARY OF THE INVENTION

In a first manifestation, the invention is a method for creating, managing, customizing, distributing, verifying, monitoring or invoicing an advertising spot with an inner message in association with an advertiser. In this manifestation, a hub is connected into a computer network. Basic content is developed, and at least one inner message is created. An advertiser or system administrator will establish controls for directing the integration of inner message with basic content, and at least one inner message and controls are transmitted through the computer network to the hub. Signal space is formed for the at least one inner message responsive to the controls, and inner messages are introduced into basic content responsive to the controls, thereby forming a spot with inner message. Once formed, the spot with inner message is distributed through a distribution network and tracked. An invoice entry is produced responsive to distributing and tracking. The advertiser is then invoiced through the computer network.

In a second manifestation, the invention is a method for improving the control an advertiser can exert over an advertisement through a combined audio and video medium. In this method, Internet access is provided to an advertiser through an Internet-connected computer. Interface software is installed within the Internet-connected computer which enables the advertiser to use the Internet-connected computer to perform data input, data transmission, and invoice receipt through the Internet. The Internet-connected computer is next enabled to electronically exchange data with an Internet-connected hub. The Internet-connected hub receives data input from the Internet-connected computer, and in turn transmits the data from hub to a video dub station. An identification code is inserted into an A/V signal responsive to data transmitted from the hub to form an air play source signal at the video dub station. The air play source signal is ultimately selected for transmission to a plurality of A/V receivers, and the identification code in the air play source signal is detected. This detection causes a combining of inner message with air play source signal to produce a video composite signal, which is then broadcast.

### OBJECTS OF THE INVENTION

Exemplary embodiments of the present invention solve inadequacies of the prior art by providing advertising spots that are generated globally and subsequently adapted to satisfy one or many local applications. The adaptations are initiated most preferably by an advertiser or administrator through Internet access in real time. Adaptations, station verification, adapting the actual video/audio stream, logging and invoicing are all performed automatically and in real time. Consequently, an advertiser can ascertain effectiveness and cost immediately, as desired.

A first object of the invention is to reduce the time and expense required to adapt a television advertisement to a limited subset of a market. A second object of the invention is to enable an advertiser to directly control the adaptation in real time, so that the advertiser may make updates and modifications competitively with print, radio and other heretofore more readily adapted media. A further object of the invention is to enable data to be collected and analyzed by an advertiser at the convenience of the advertiser, regardless of the sampling period preferred by the advertiser. Yet another object of the present invention is to allow an advertiser to maintain basic or global content unaltered except for scaling, and display custom messages or graphics in the margins. A still further object of the invention is to enable a broadcaster to deliver custom messages in real time without additional human intervention, and with a minimum of overhead. Another object is to allow an advertiser to customize advertising spots to specific single station broadcasts at a particular time of day, to gain the greatest advertising benefit possible. These objects are most desirably accomplished without the risk of privacy invasion or other undesired side effect which might otherwise limit acceptance.

### BRIEF DESCRIPTION OF THE DRAWINGS

The foregoing and other objects, advantages, and novel features of the present invention can be understood and appreciated by reference to the following detailed description of the invention, taken in conjunction with the accompanying drawings, in which:

FIG. 1 illustrates an exemplary organization of advertisers, hub, and video/audio servers schematically, arranged in accord with the teachings of the present invention, and wherein it will be understood that the connecting lines represent what are typically two-way communications channels.

FIG. 2 illustrates an exemplary video dub station by block diagram, organized in accord with the most preferred organization of FIG. 1.

FIG. 3 illustrates an exemplary video output path by block diagram which is compatible with the most preferred organization of FIG. 1.

FIG. 4 illustrates a preferred method for creating, managing, customizing, distributing, verifying monitoring or invoicing an advertising spot.

FIG. 5 illustrates a preferred method for improving the control an advertiser can exert over an advertisement transmitted through an A/V medium.

### DESCRIPTION OF THE PREFERRED EMBODIMENT

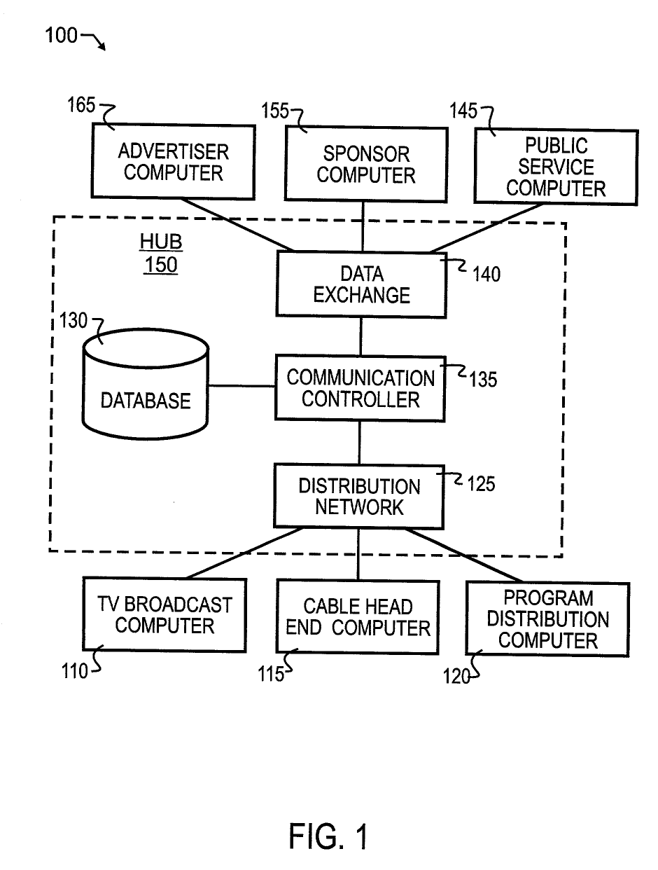

Manifested in the preferred embodiment, which is given to illustrate the invention rather than to limit its scope, the present invention provides a simplified, more precise and more rapid method for customizing combined audio and video advertising spots than was heretofore available. As illustrated in FIG. 1, advertising system 100 includes a hub 150 having communications links to one or more advertiser computers 165, sponsor computers 155 and public service computers 145. These computers 145, 155, and 165 are illustrated for exemplary purposes only, and may constitute one or a myriad of computers which are used by those who wish to advertise through video distribution. Most preferably, each of computers 145, 155 and 165 are desktop personal computers, and the most preferred communications link between these computers and hub 150 is through the Internet. Since messages transmitted over the Internet are not secure, each of computers 145, 155 and 165 will most preferably be provided with data encryption software and associated passwords. This arrangement of desktop computers, Internet, and encryption software is most preferred, owing to the high prevalence of personal computers, ready maintenance of these computers at the location of the advertiser, ease of Internet access, and availability of effective encryption software. The use of Internet access also assures an advertiser the opportunity to perform updates remotely from a place of business, should the need arise, such as through a laptop computer or cellular telephone. In other words, most preferably the present advertising system 100 does not introduce technologies or equipment which will not be readily maintained by an advertiser, sponsor or the like. In the event an advertiser already maintains a different type of computer or operates a different communications link, such an interface would be readily coupled to hub 150 as well.

Within an advertiser, sponsor or public service computer 145, 155, 165 custom software will also be installed, most preferably which provides an easy to use user interface which allows the advertiser to create controls that dictate which inner messages are displayed, when, and in what markets. In one preferred embodiment, a simple input form may be provided which polls the advertiser for information regarding the advertising spot and inner messages. Options may be provided, such as updating an advertising spot in all markets, performing an update in one or several specific geographic regions, updating a spot at one or a plurality of specific stations, or in one or a plurality of advertising markets. These forms may be provided with basic data verification and validation, to immediately notify the advertiser if data has been improperly entered. One example may be the verification of valid stations for updating. This type of verification and validation of an advertiser's selections may also be made, or may be made instead at hub 150, as may be appropriate for a particular application or system 100. Most preferably, the custom software used by the advertiser will be enabled to allow the advertiser to include and even create custom graphics as well as text.

Hub 150 maintains communications with each of the computers 145, 155, and 165 through data exchange interface 140, which will typically be an Internet server or the like which is capable of processing substantial amounts of communicated data rapidly. Hub 150 is similarly connected to one or more distribution computer systems, such as are graphically illustrated in FIG. 1 by television broadcast computer 110, cable head end computer 115, and program distribution computer 120. Interconnection between hub 150 and each of the distribution computer systems 110-120 may be made through any suitable communications channel, but owing to the potential bandwidth required to manage a plurality of advertisers providing input to a single broadcast system such as TV broadcast computer 110, it is preferable to ensure sufficient bandwidth capacity. This may be achieved through high speed Internet connections, satellite link, trunk line, cable, Local Area Network or the like.

Within hub 150 a communication controller 135 is programmed to perform a variety of functions, most which will be outlined in more detail later. A database 130 will typically be provided within hub 150, for storing important information such as taboo words, advertiser addresses, information about broadcast computers and other important information. One very important role for communication controller 135 and database 130 is the censoring of advertising inner messages. To preserve the morals of a community or broadcast station, and still provide substantial control over content with an advertiser, electronic censoring is most preferably incorporated. Each inner message will preferably be screened by comparison with the list of “taboo” words or phrases, and, in the event a word is detected that should be censored, the message is preferably blocked from further transmission. In this instance, the advertiser will preferably be advised, as will system security. Another role performed by communications controller 135 is to receive and evaluate the controls received from an advertiser, and identify which broadcasters to communicate with.

As aforementioned, data exchange interface 140 provides communications to advertiser computers. Distribution network interface 125 provides similar communications capability, though typically of higher bandwidth, with the various broadcast computers 110-120. Where rapid turnaround is not required, distribution to the various broadcast computers 110-120 may alternatively occur in the form of magnetic or optical media rather than through high-speed real time connection.

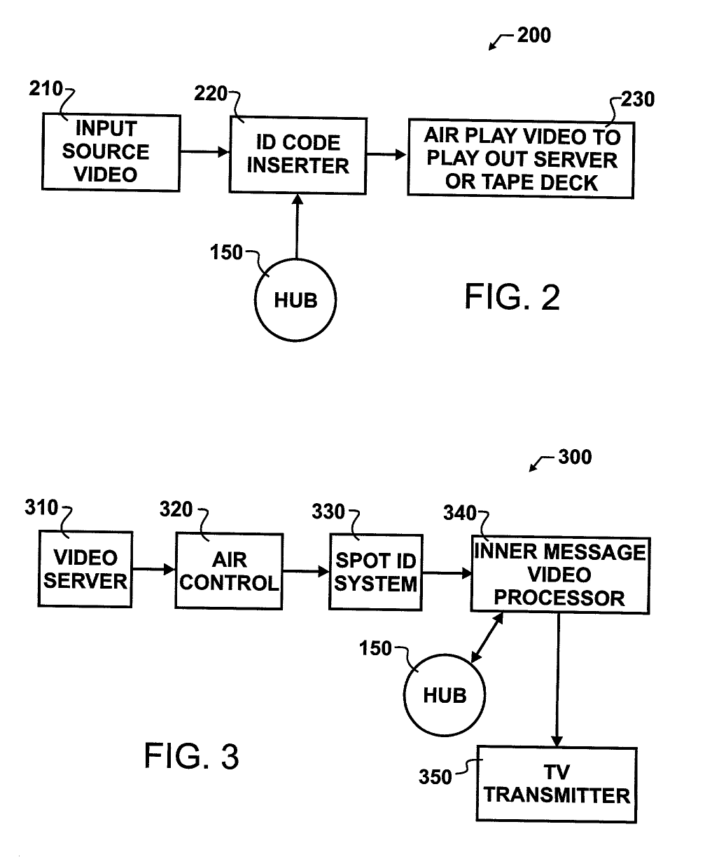

FIG. 2 illustrates a typical video dub station 200, such as might be located at a television broadcast facility in accord with the teachings of the present invention. Other facilities remote from a broadcast station may be used, but the basic hardware already on hand that most television facilities will dictate in most instance the housing of dub station 200 there. Once again and wherever possible, equipment which is familiar to operators of a television station will most preferably be used.

Video dub station 200 includes an input video source 210 which may comprise any suitable hardware, though modern equipment frequently includes video tape recorders, laser and other computer optical discs, computer hard drives, and the like. Into a video signal provided by input video source 210, an identification code is inserted by ID code inserter 220. The identification code is used to uniquely identify the particular video spot, which may frequently be an advertisement. In a preferred embodiment, this identification includes the name of the spot, a description, and the air play date. This information will preferably be inserted into an area of the video that is not visible to a home TV viewer. Once the video has been uniquely identified by identification code, the signal will be transferred to a playout server or tape deck, such as video server 310 of FIG. 3, through air play video output 230. Most preferably, when one or more ID codes have been inserted, this information is relayed back to hub 150 to register which stations have prepared the videos for playback.

Input video signals which are delivered by input video source 210 will typically include global advertising spots. As noted herein above, the term global is used broadly herein to identify a spot which is used for more than one local broadcast or locale. The global signal, owing to the wider distribution, may be prepared using the typical advertising spot preparation techniques, including development through a video production studio or the like. The expense of such a production would not normally be justifiable for a single market or locale, but when the expense can be distributed through many markets, such production frequently becomes quite economical. Once generated, the advertising spot must be uniquely identified, so that a distinct inner message may be applied uniquely to that advertising spot and not to other advertisers' spots. As noted, the unique identification occurs through identification code inserter 220.

Once identified, the advertising spot is cued for distribution in video server 310. Air control 320 pulls the video signals from video server 310 as required for broadcasting. Spot identification system 330 reviews the video signals delivered from air control 320 for advertising spots that have an identification code inserted therein. This identification is used to trigger inner message video processor 340 to perform several very important functions.

Upon detection of a spot identification, inner message video processor 340 will be activated to insert the appropriate inner message into the advertising spot. Most preferably, this insertion will be accomplished by reducing the original video spot while the aspect ratio is maintained. For those unfamiliar with aspect ratio, that is the ratio of the height to width. By maintaining the aspect ratio, the original image remains undistorted, though slightly smaller. Within the margins that remain around the now reduced video image, one or more inner messages may be inserted. The reduced global image, which will also be referred to herein as basic content, may be shifted after reduction to align with one corner. For exemplary purposes, the image may be aligned with the top right corner of the television picture, which would free up space along the left side of the picture and also along the bottom side. While size reduction is most preferred, those skilled in the art will recognize that various overlay techniques also exist that could be implemented. Furthermore, the present invention is not limited to text inner messages, but may include graphics or other content as well.

In addition to inserting inner messages, inner message video processor 340 will also relay to inner hub 150 various accounting information. Most preferably, the communication will establish where the message was displayed, the time and date of the display, and the duration. Hub 150, through communication controller 135 and database 130, will use this information to generate advertiser logs and invoices, which are ultimately transmitted through data exchange interface 140 to the appropriate advertiser. In a preferred embodiment, hub 150 will generate invoices during the night, when demand on hub 150 is at a minimum. However, should there be a desire to provide logs and invoicing in real time, this capability may be provided through more robust hub 150 hardware and good communications channels. Additional reports may be automatically distributed electronically to a distribution list specified by the advertiser.

Inner message video processor 340 also receives advertiser inner messages and controls from hub 150 which identify the advertising spot of interest, inner messages to be inserted into that spot, and the time and date for insertion. The inner messages are stored and available for use, and the controls are saved until all appropriate insertions are made. Consequently, a database or other data retrieval will be used within inner message video processor 340, similar to database 130 within hub 150.

Once processed by inner message video processor 340, the video output signal is then sent to the television transmitter circuitry 350, which may for example be radio frequency broadcasting circuits, cable head end circuits, satellite transmitters or other similar broadcasting equipment, for final distribution to television receivers or other transmission receivers. In a most preferred embodiment, this distribution occurs without need for special receivers or equipment at the transmission receiver within a household or the like. This is important, since an advertiser may target relatively specific audience profiles that are known to watch a particular program or station at a particular time of day or day of week, without invading the privacy of the viewer, or requiring any personal information associated with that viewer.

As should now be apparent, an advertiser has tremendous control over the production and presentation of an advertising spot. Depending upon the globally developed basic content, the advertising spot may appear to a viewer to be entirely developed as a single unit, with the inner messages indistinguishable from the basic content, or, alternatively, an advertiser may choose to call attention to the inner message. Furthermore, since the broadcast component of the system is implemented electronically, there is no additional burden placed upon a broadcaster in terms of human interventions or labor. The advertiser is able to control the content in real time, and also select which markets and times the advertising spots are delivered into. Since inner message video processor 340 operates to update an advertising spot as the signal is being prepared for final distribution and broadcast, an advertiser may update an inner message almost simultaneously with the time the spot is to be aired. Consequently, an advertiser may generate an inner message for broadcast through a particular broadcast station that, for example, issues a breakfasts special at the advertiser's food establishment. Only a few hours later, and perhaps while a different inner message advertising a lunch special is being broadcast, the advertiser will have received the invoicing for the advertising spot, and may immediately review the success of the advertising spot. If the spot was not as successful as desired, a different inner message may be prepared for the next morning, to attempt to improve the success of the ad, or the ad may be broadcast through a different market or set of broadcasters. In very little time, an advertiser may, through the teachings of the present invention, fine tune an advertisement to optimize return, therefore justifing greater cost for the custom ad spot. This in turn provides a greater revenue stream for the broadcaster, while also offering advertising which directly and successfully competes with radio and which surpasses printed media such as newspapers in terms of flexibility. Once again, all of this may be accomplished through the control and efforts of the advertiser, without requiring special expertise from the advertiser, and without intervention by a broadcaster.

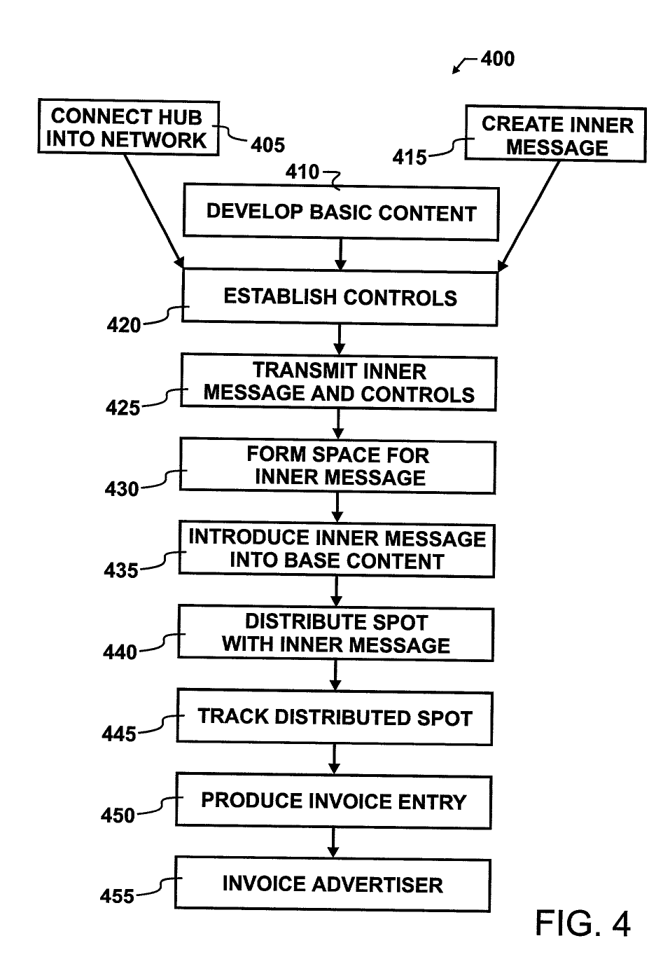

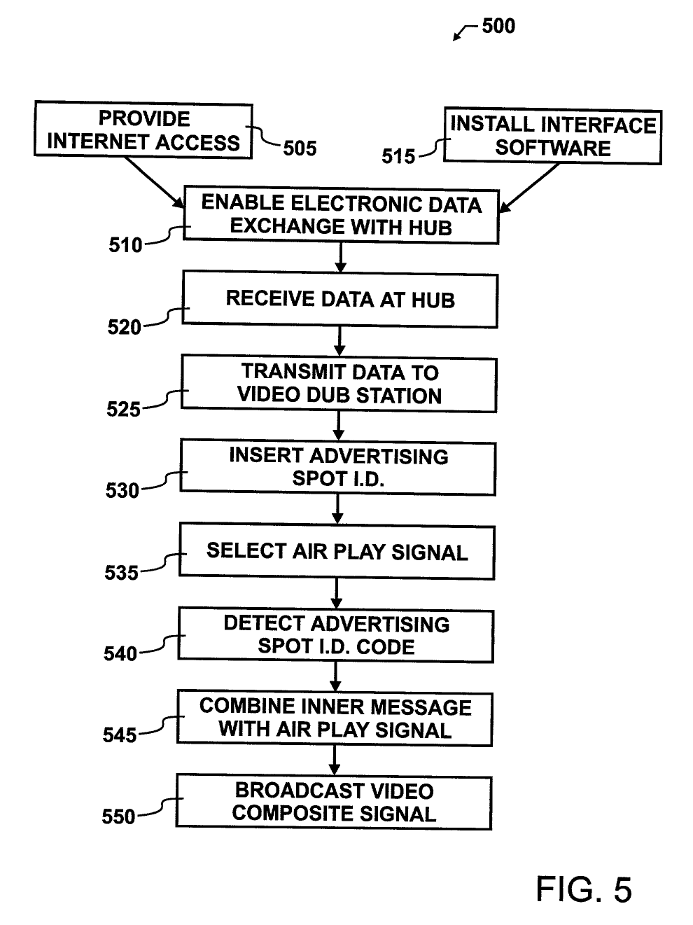

FIGS. 4 and 5 illustrate the preferred and alternative methods generally by flow chart. FIG. 4 illustrates a method 400 for creating, managing, customizing, distributing, verifying, monitoring or invoicing an advertising spot with an inner message in association with an advertiser. In this method, a hub is connected into a computer network in step 405. Basic content is developed in step 410, and at least one inner message is created in step 415. An advertiser or system administrator will establish controls for directing the integration of inner message with basic content in step 420, and at least one inner message and controls are transmitted through the computer network to the hub in step 425. Signal space is formed for the at least one inner message responsive to the controls in step 430, and inner messages are introduced into basic content responsive to the controls, thereby forming a spot with inner message, at step 435. Once formed, the spot with inner message is distributed through a distribution network in step 440 and tracked at step 445. An invoice entry is produced responsive to distributing and tracking in step 450. The advertiser is then invoiced through the computer network in step 455.

FIG. 5 illustrates a method 500 for improving the control an advertiser can exert over an advertisement through a combined audio and video medium. In this method, Internet access is provided to an advertiser through an Internet-connected computer in step 505. Interface software is installed within the Internet-connected computer which enables the advertiser to use the Internet-connected computer to perform data input, data transmission, and invoice receipt through the Internet in step 515. The Internet-connected computer is next enabled to electronically exchange data with an Internet-connected hub in step 510. In step 520, the Internet-connected hub receives data input from the Internet-connected computer, and in turn transmits the data from hub to a video dub station in step 525. An identification code is inserted into an A/V signal responsive to data transmitted from the hub to form an air play source signal at the video dub station in step 530. The air play source signal is ultimately selected for transmission to a plurality of A/V receivers in step 535, and the identification code in the air play source signal is detected at step 540. This detection causes a combining of inner message with air play source signal to produce a video composite signal in step 545, which is then broadcast in step 550.

Industrial Applicability

The present invention has applicability not only to commercial advertising, but to various other sponsors, such as political candidates and public service and non-profit institutions. The ability to customize a message for specific target audiences is of much value in political advertising and in many other diverse applications. Additionally, emergency broadcast systems, which have failed or been inactivated by local broadcasters in the past, may be more readily implemented without a broadcaster fearing loss of viewers. Consequently, the hardware incorporated in the present invention has applicability not only to advertising but also in various public service applications.

While the foregoing details what is felt to be the preferred embodiment of the invention, no material limitations to the scope of the claimed invention are intended. Further, features and design alternatives that would be obvious to one of ordinary skill in the art are considered to be incorporated herein. The scope of the invention is set forth and particularly described in the claims hereinbelow.

We claim:

1. A method for creating, managing, customizing, distributing, verifying, monitoring or invoicing an advertising spot with an inner message in association with an advertiser, comprising the steps of:
connecting a hub into a computer network;
developing basic content;
creating an at least one inner message;
establishing controls for directing the integration of said at least one inner message with said basic content;
transmitting said at least one inner message and said controls through said computer network to said hub;
forming signal space for said at least one inner message responsive to said controls;
introducing said at least one inner message into said basic content responsive to said controls, thereby forming a spot with inner message;
distributing said spot with inner message through a distribution network;
tracking said distributed spot with inner message;
producing an invoice entry responsive to said distributing and said tracking steps; and
invoicing said advertiser through said computer network.

2. The method for creating, managing, customizing, distributing, verifying, monitoring or invoicing an advertising spot with an inner message of claim 1, further comprising the steps of:
comparing a text content of said inner message with a list of unacceptable words;
censoring said inner message responsive to a match between said inner message and said list of unacceptable words; and
signaling system security responsive to said match.

3. The method for creating, managing, customizing, distributing, verifying, monitoring or invoicing an advertising spot with an inner message of claim 1, wherein said basic content is developed as global content for integration with all local inner messages.

4. The method for creating, managing, customizing, distributing, verifying, monitoring or invoicing an advertising spot with an inner message of claim 3, wherein said step of creating said at least one inner message occurs specific to a locale.

5. The method for creating, managing, customizing, distributing, verifying, monitoring or invoicing an advertising spot with an inner message of claim 1, wherein said basic content contains both audible and visual content.

6. The method for creating, managing, customizing, distributing, verifying, monitoring or invoicing an advertising spot with an inner message of claim 5, wherein said controls are selected from the group comprising: time of day; day of week; market outlet; and advertising spot identification.

7. The method for creating, managing, customizing, distributing, verifying, monitoring or invoicing an advertising spot with an inner message of claim 5, wherein said step of forming further comprises reducing said basic content in size, while maintaining an aspect ratio of said basic content throughout said forming step.

8. The method for creating, managing, customizing, distributing, verifying, monitoring or invoicing an advertising spot with an inner message of claim 1, wherein said computer network is selected from the group comprising: satellite communications network, Internet, Local Area Network (LAN), and cable network.

9. The method for creating, managing, customizing, distributing, verifying, monitoring or invoicing an advertising spot with an inner message of claim 1, wherein said distribution network is selected from the group comprising: radio wave broadcasts, cable, Internet, and Local Area Network (LAN).

10. A method for improving the control an advertiser can exert over an advertisement through a combined audio and video medium, comprising the steps of:
providing Internet access to said advertiser through an Internet-connected computer;
installing interface software within said Internet-connected computer which enables said advertiser through said Internet-connected computer to perform data input, data transmission, and invoice receipt through said Internet;
enabling said Internet-connected computer to electronically exchange data with an Internet-connected hub;
receiving data input from said Internet-connected computer at said Internet-connected hub;
transmitting data from said hub to a video dub station responsive to said data receiving step;
inserting an advertising spot identification code into an A/V signal responsive to said data transmitting step to form an air play source signal;
selecting said air play source signal for transmission to a plurality of AN receivers;
detecting said advertising spot identification code in said air play source signal;
combining an inner message with said air play source signal to produce a video composite signal; and
broadcasting said video composite signal.

11. The method for improving the control an advertiser can exert over an advertisement of claim further comprising the steps of:
monitoring a date and time of detecting said advertising spot identification code; and
invoicing said advertiser responsive to said monitoring.

12. The method for improving the control an advertiser can exert over an advertisement of claim 10, wherein said step of combining further comprises the steps of.
reducing said AN signal display size while maintaining aspect ratio; and
adding said inner message within a display region occupied by said AN signal prior to said reducing but unoccupied subsequent thereto.

13. The method for improving the control an advertiser can exert over an advertisement of claim 10, further comprising the steps of:
detecting inappropriate content in data received at said hub; and
ignoring said received data responsive to said detecting step.

14. The method for improving the control an advertiser can exert over an advertisement of claim 10, wherein said enabling step further comprises causing said Internet-connected computer to encrypt data prior to transmission through said Internet to said hub.

15. The method for improving the control an advertiser can exert over an advertisement of claim 10, wherein said broadcasting is through the air at radio wave frequencies available for unrestricted reception.

16. The method for improving the control an advertiser can exert over an advertisement of claim 10, wherein said broadcasting is through the a cable distribution network.

17. The method for improving the control an advertiser can exert over an advertisement of claim 10, wherein said broadcasting is through the Internet.
